(19) United States
(12) Patent Application Publication
(10) Pub. No.: US 2013/0220360 A1
(43) Pub. Date: Aug. 29, 2013

(54) Hair Styling Apparatus and Method of Making Same

(71) Applicant: Nir Sharon, Bonita Springs, FL (US)

(72) Inventor: Nir Sharon, Bonita Springs, FL (US)

(21) Appl. No.: 13/409,071

(22) Filed: Feb. 29, 2012

(51) Int. Cl. A45D 2/40; C04B 35/52; B05D 1/28

(52) U.S. Cl. 132/269; 427/180; 501/1

(57) ABSTRACT

A hair styling device including a first handle and a second handle; a first plate extending from said first handle and having a first heating element within said first plate, a second plate extending from said second handle and having a second heating element within said second plate, a hinge connecting said first handle and second handle, wherein said first and second plates are adapted to pivot relative to said first and second handles about an axis generally perpendicular to a longitudinal axis of said first and second handles, and wherein said first and second plates comprise a diamond dust protective layer between the heating elements and the respective plates.

### FIELD OF INVENTION

The present invention relates to hair styling devices, and more particularly to hair styling devices which have a heating element for heating and styling hair.

### BACKGROUND OF THE INVENTION

Typical flat irons comprise two pivotable handles, hinged together at one end, and having heated plates extending from each handle. The plates have inner surfaces that face each other and that are comprised of a heatable material, usually metal, for straightening or styling hair. An electric heater element located beneath each heatable surface is activated to warm the surfaces to a desired temperature. The inner surfaces are positioned around one or more stands of hair to be styled, and the hinged handles are closed toward each other, thus bringing the heated inner surfaces toward each other to close around the hair strands. The gripped handles are then slid relative to the hair strands, so as to run along the length of the strands of hair until the strands exit from between the plates.

The plates of conventional hair straighteners get extremely hot while in use, but unfortunately the plates do not distribute heat evenly. As a result, conventional flat irons (also referred to herein as “hair straighteners”) can damage a user's hair due to the extreme heat and the hot spots created along the surface of the plates.

Similarly, conventional curling irons use metal bands that do not distribute heat evenly along the length and around the barrel. As a result, curling irons also have hot shots along their length, which can damage a user's hair.

Thus, there is a need for hair styling devices, such as hair straighteners, curling irons, and hair dryers, with heated surfaces that distribute heat evenly and which are less likely to generate hair-damaging hot spots.

### SUMMARY

The present invention solves the foregoing problems by providing a hair styling device with a diamond dust protective layer between the heating element and that portion of the hair styling device that comes into contact with a user's hair. The hair styling device of the present invention more evenly distributes heat along the length of the heating element and/or the heat applying means, thereby reducing the risk of heat damage to a user's hair.

In one embodiment of the invention, a hair styling device includes a first handle and a second handle; a first plate extending from said first handle and having a first heating element within said first plate, a second plate extending from said second handle and having a second heating element within said second plate, a hinge connecting said first handle and second handle, wherein said first and second plates are adapted to pivot relative to said first and second handles about an axis generally perpendicular to a longitudinal axis of said first and second handles, and wherein a diamond dust protective layer is positioned between the heating elements and the respective plates.

A feature of the invention is that diamond dust applied to a hair styling device having a heating element and heated plates, such that heat from the heating element is evenly distributed along the heated plates.

Another feature or the invention is a tourmaline ceramic coating that helps distribute heat evenly along the length of a barrel within a curling iron or a heatable plate in a hair straightener, thereby eliminating hot spots and reducing the likelihood of heat damage to a user's hair.

An advantage of the invention is that, due to the excellent heat conductivity of diamond dust, the invention has improved heat distribution across the entire heating plate thereby improving the performance of the hair styling device.

Another advantage of the invention is that, unlike conventional flat irons which use metal plates that heat unevenly along their length thus creating hair-damaging hot spots, the present invention provides even heat distribution along the length of the hair styling device.

### BRIEF DESCRIPTION OF THE DRAWINGS

The present invention is more fully understood by reference to the following detailed description of an illustrative embodiment with the drawings identified below.

FIG. 1 is a top view image of a device according to one of many possible embodiments of the invention.

FIG. 2 is a partial perspective view of the plate portions of the present invention.

FIG. 3 is a perspective view of a device according to the present invention.

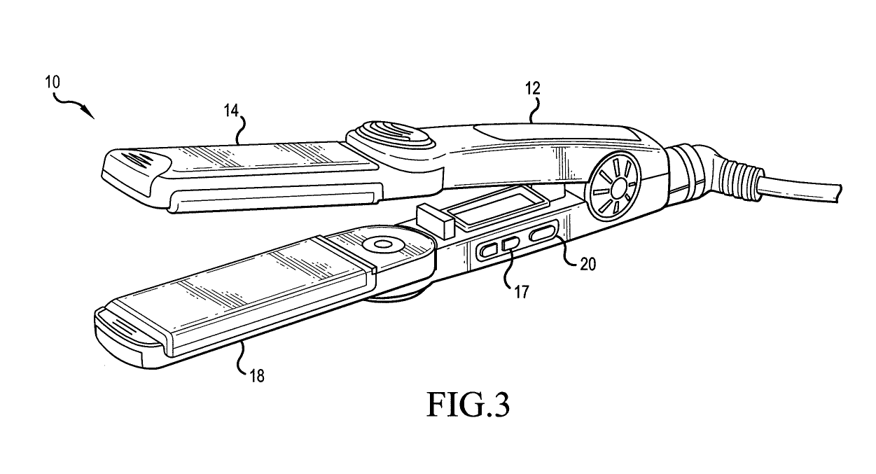

FIG. 4 is a top view of a heating element coated with diamond dust and first and second heatable plates.

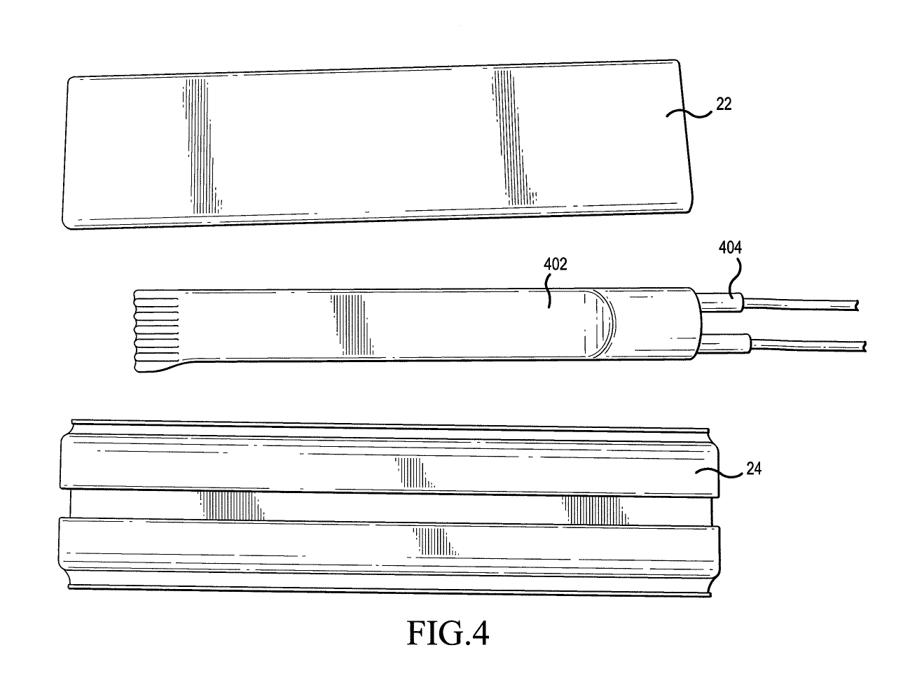

### DETAILED DESCRIPTION

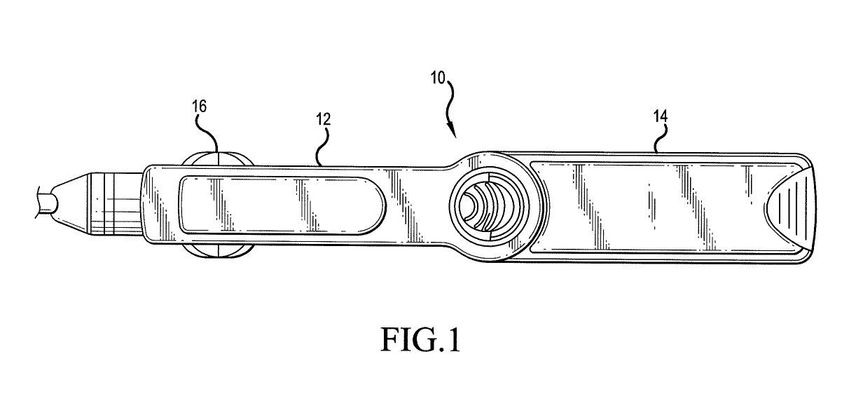

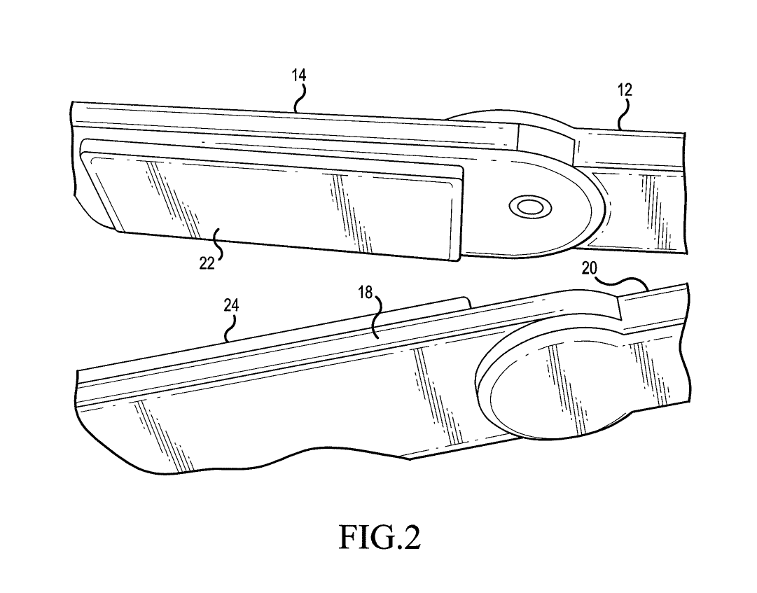

Referring to the drawings, and more specifically to FIGS. 1 and 2, a flat iron device has a handle portion 12 and a plate portion 14 joined by a spring-biased hinge 16 to another plate portion 18 and handle portion 20. The handle portions 12, 20 are biased away from each other by the spring-biased hinge 16, as is known in the art. Each plate portion 14, 18 has a heatable plate 22, 24, heated by conventional electrical means, such as a heating element 404, so that hair can be positioned between the plates 22, 24 for styling. The handles 12, 20 can contain control buttons 17 to operate the device 10.

According to one aspect of the invention, a protective layer 402 can be applied to one or both plates 22, 24, and/or to the heating element 404 to evenly distribute heat along the plates 22, 24 and protect a user's hair from heat damage. In a preferred embodiment, the protective layer 402 is diamond dust added to the plates 14, 18. The heatable surfaces of the plates 22, 24 may be made of any of metal, such as aluminum or aluminum oxide, ceramic, ceramic-coated materials, glass, tourmaline ceramic, porcelain, jade, or other heatable surfaces. Alternatively, the protective layer 402 may be applied along the length of a heating element 404, which is positioned in or under one or more of the plates 22, 24.

In one embodiment of the invention, the plates 22, 24 are made of aluminum oxide. While the aluminum is in a liquid state, diamond dust is added to the liquid aluminum. The aluminum and diamond dust mixture is then removed from the container and placed into a stamping machine at which time oxygen is added to the combination of aluminum and diamond dust. The plates 22, 24 are thus formed with a protective layer of diamond dust added to their surfaces. Alternatively, the diamond dust can be added to the plates 22, 24 after they are formed. For example, the diamond dust can be applied after the aluminum plates are created by dipping a small brush into the diamond dust and applying the diamond dust to the outer surface of the plates 22, 24. A strong protective layer is created between the plates 22, 24 and the heating element. The amount of diamond dust applied to the plates can vary.

In an alternative embodiment, the plates 22, 24 are made of aluminum covered by ceramic. Ceramic oil is combined with a desired paint color and mixed together. Powdered diamond dust is then added to the mixture, which is painted on top of an aluminum plate. Thus, the plates 22, 24 have a coating of ceramic oil paint and diamond dust. The amount of diamond dust per plate can vary, and preferably ranges from about 0.01 gram to 8 grams of diamond dust. Every 1 gram of diamond dust contains approximately 0.5 carat of diamonds.

In another alternative embodiment, the plates 22, 24 are made entirely of ceramic. Diamond dust is added to ceramic liquid, which is then placed in an oven and baked at high temperature, e.g., approximately 1000 degrees Celsius to form the plates 14, 18.

In operation, either the plates 22, 24, whether aluminum, ceramic-covered aluminum, or ceramic, of the heating element 402 will contain a diamond dust coating. The diamond dust forms a strong layer of protection between the hot plates 22, 24 and a user's hair, and between the hot plates 22, 24 and the heating element 402. As a result, the device 10 of the present invention reduces the likelihood of heat damage to hair that is being styled with the device 10 because of a protective layer between the hot plates 14, 18 and the hair, and because the layer of diamond dust will more evenly conduct heat along the length of the hot plates 14, 18.

An alternative embodiment of the invention comprises a curling iron, which includes a cord, a handle and a metal barrel for curling a user's hair. The metal barrel can be an aluminum barrel that is placed on top of the handle. Inside the handle, underneath the barrel, there is a hearing element that generates and conducts heat, thereby heating the barrel during use. The metal barrel can be covered with a tourmaline ceramic cover. Ceramic oil can be combined with a desired paint color and two can be mixed together. Powered diamond dust can be added to the mixture, which is painted on top of the aluminum barrel. The curling iron may or may not have a metal clip on top of it. The size of the barrel may vary from between about 13 mm to about 32 mm.

In another alternative embodiment of the invention, the hair styling device is a blow dryer. Inside, the blow dryer can include a metal coil shaped as a circle. The blow dryer produces hot air that is directed toward a user's hair. The metal coil can be coated with a layer of diamond dust to protect and increase the thermal conductivity of the coil, thus increasing, the life of the blow dryer and creating a safer device for the user.

Diamond dust can be applied to the blow dryer by dipping a small brush into the diamond dust and gently applying it to the metal coil inside the dryer, thereby creating a strong protective layer of diamond dust, which improves the thermal conductivity and improves the performance of the hair dryer. The amount of diamond dust applied may vary.

### CONCLUSION

While various embodiments of the present invention have been described above, it should be understood that they have been presented by way of example only, and not limitation. It will be understood by those skilled in the art that various changes in form and details may be made therein without departing from the spirit and scope of the invention. Thus, the breadth and scope of the invention should not be limited by any of the above-described exemplary embodiments.

What is claimed is:

1. A hair styling device, comprising: a first handle and a second handle; a first heatable plate extending from said first handle, a second heatable plate extending from said second handle; one or more heating elements disposed either within each of the first and second plates or positioned under one or both plates to heat one or both plates during use; a hinge connecting said first handle and second handle, wherein said first and second plates are adapted to pivot relative to said first and second handles about an axis generally perpendicular to a longitudinal axis of said first and second handles; and a protective layer applied either to the one or more heating elements or to one or both plates for reducing heat damage to a user's hair during styling.

2. The hair styling device of claim 1, wherein said protective layer is diamond dust.

3. The hair styling device of claim 2, wherein said hair styling device comprises between about 0.01 gram and 8 grams of diamond dust.

4. The hair styling device of claim 1, wherein the first and second plates are made of one or a combination of aluminum, aluminum oxide, ceramic, glass, tourmaline ceramic, porcelain, titanium, or jade.

5. A hair styling device, comprising: a first handle and a second handle; a first plate extending from said first handle and having a first heating element within said first plate, a second plate extending from said second handle and having a second heating element within said second plate, a hinge connecting said first handle and second handle, wherein said first and second plates are adapted to pivot relative to said first and second handles about an axis generally perpendicular to a longitudinal axis of said first and second handles and wherein said first and second plates comprise a protective layer for preventing heat damage to a user's hair during styling; wherein said protective layer is diamond dust and further wherein the first and second plates are made of one or more of a combination of aluminum oxide, ceramic, glass, tourmaline ceramic, porcelain, titanium, or jade.

6. The hair styling device of claim 5, wherein said hair styling device comprises between about 0.01 gram and about 8 grams of diamond dust.

7. A method of making a heating plate for a hair styling device, comprising:
adding diamond dust to a ceramic liquid;
placing the ceramic liquid and diamond dust mixture in an oven at high temperature, such that the ceramic is baked into a solid plate.

8. A method of making a hair styling device said hair styling device having a heating plate for applying heat to a user's hair and a heating element under the heating plate for, comprising:
applying diamond dust onto a heating plate, such that the diamond dust is situated between the heating plate and a heating element positioned under the heating plate.

9. The method of claim 8, wherein the heating plate is made of one or more of a combination of aluminum, aluminum oxide, ceramic, glass, tourmaline ceramic, porcelain, titanium, or jade.

10. The method of claim 8, wherein the diamond dust is applied by brushing the diamond dust onto the outer surface of the heating plate.
